(19) United States
(12) Patent Application Publication
(10) Pub. No.: US 2025/0125896 A1
(43) Pub. Date: Apr. 17, 2025

(54) NETWORK-BASED TIME SYNCHRONIZATION

(71) Applicant: Intel Corporation, Santa Clara, CA (US)

(72) Inventors: David R. MULVIHILL, Fort Collins, CO (US); Srinivasan S. IYENGAR, Fremont, CA (US); Mark BORDOGNA, Andover, MA (US); Subrahmanya Kumar KUCHIBHOTLA, Bangalore (IN)

(21) Appl. No.: 19/000,227

(22) Filed: Dec. 23, 2024

(51) Int. Cl. H04J 3/06; H04W 56/00

(52) U.S. Cl. CPC H04J 3/0658; H04W 56/001

(57) ABSTRACT

Examples described herein relate to a timing source. In some examples, the timing source generates a clock signal by synchronization with a second clock signal from a crystal source and subsequent synchronization with a third clock signal. In some examples, the third clock signal is synchronized to timing signals received in Ethernet packets. In some examples, the crystal source is to provide the second clock signal to the circuitry via the interface.

### DESCRIPTION

Applications can be executed on distributed computing nodes to scale up the processing capability of the applications. Aligning time stamp counters for processor nodes that execute the applications to a common clock source is utilized to time synchronize operations of the applications. For example, Radio Access Networks (RANs) have stringent requirements on Time Transmit Intervals (TTI) and corresponding time synchronization accuracy among the distributed computing nodes. For example, in 4G or 5G applications, the radio frames are sent to an antenna at 10 millisecond (ms) intervals so that base stations are time synchronized and meet the timing standards at the antenna.

### BRIEF DESCRIPTION OF THE DRAWINGS

FIG. 1 depicts an example system.

FIG. 2 depicts an example system.

FIG. 3 depicts an example system.

FIG. 4 depicts an example of signals.

FIG. 5 depicts an example process.

FIG. 6 depicts a network interface.

FIG. 7 depicts an example system.

### DETAILED DESCRIPTION

At start-up or boot of a host system, a clock signal from a clock source can be available before a clock signal synchronized to a network clock is available. The host system can synchronize a reference clock source to the clock signal from the clock source before the clock signal based on network time is available. After the clock signal synchronized to network time is available, the reference clock source can synchronize the clock signal to the clock signal synchronized to the network clock.

Various examples of technologies to generate the reference clock can used with distribution of time-oriented applications across processor nodes such as but not limited to 4G/5G applications, distributed microservices or applications in cloud computing that rely on a network or global time, a centralized node in a Radio Access Network (RAN) where there is one timing reference for multiple RAN applications, financial transactions such as trading, or execution of microservices, virtual machines, or containers. Multi-homed environments can apply examples described herein where different non uniform memory access (NUMA) nodes or systems with different time domains.

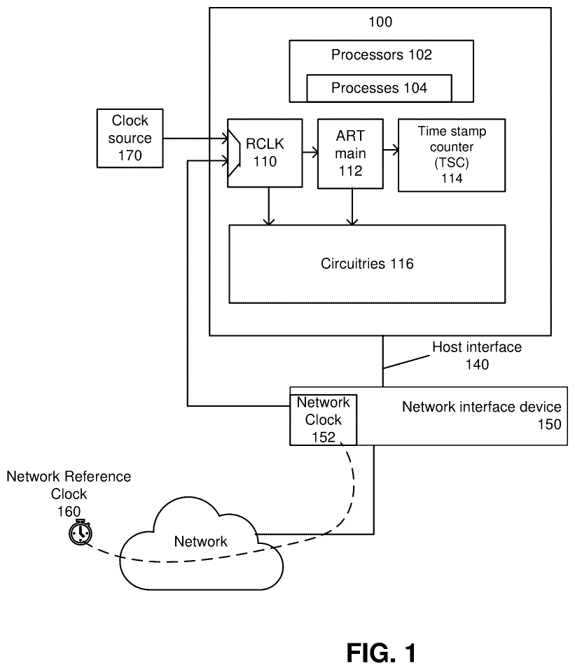

FIG. 1 depicts an example system. At start-up or boot of host system 100, host system 100 can synchronize a clock signal generated by reference clock source (RCLK) 110 to a clock signal from clock source 170 before a clock signal based on network time is available from network clock 152 from network interface device 150. In some examples, clock source 170 can provide a clock signal to system 100 generated based on a crystal oscillator. After a clock signal synchronized to network time is available from network clock 152, RCLK 110 can output a clock signal synchronized to the clock signal synchronized to network time. Network clock source 152 can generate a clock signal based on time stamps or timing signals received from network reference clock 160 by translating counter values into edges of a clock signal based at least on Precision Time Protocol (PTP) of IEEE 1588-2008.

In some examples, network clock source 152 can be generated by an Ethernet subsystem of network interface device 150, which includes transmit (TX) Ethernet ports and receive (RX) Ethernet ports, which distribute timing to host 100. Network reference clock 160 can provide a network clock signal by transmission of time stamps or timing signals to network interface device 150.

To transmit a network clock signal or timing signals from network reference clock 160, various protocols can be used. For example, transmitted network clock signal or timing signals based on network reference clock 160 can include one or more of: a counter value (e.g., counter values indicative of nanosecond increments or other units of time), time stamps relative to a reference day or time or time of day (e.g., hour: minutes: second) based on Institute of Electrical and Electronics Engineers (IEEE) 1588 PTP, a Global Navigation Satellite Systems (GNSS) time signal, or a global positioning system (GPS) time signal. IEEE 1588-2008 or other higher or lower resolution can be applied for time stamps. For example, time stamps can be represented as 96-bit counter that represents network time.

For example, RCLK 110 can utilize a dual loop phase locked loop (PLL) delay locked loop (DLL), or a clock generator that generates clock signals synchronized to the clock signal from crystal source 170. RCLK 110 can compare the clock signal output from RCLK 110 against the clock signal from network clock 152. A phase difference between the clock signals can be used to adjust a feedback path and adjust the clock signal output from RCLK 110 to match the frequency of the clock signal from network clock 152. A dual loop PLL can gradually adjust a clock signal, based on a crystal oscillator, to synchronize with network reference clock 160, based on the network domain.

Always Running Timer (ART) main 112 can receive a clock signal from RCLK 110 and ART main 112 can increment counter values based on edges of the received clock signal. Accordingly, time stamps from ART main 112 can be synchronized with network time without use of a linear or other adjustment relationship. Accordingly, time stamp values from ART main 112 and copies of the time stamp values from ART main 112 can be synchronized to network time so that host time and network time are in a same timing domain, after synchronization with a host system clock source, in order to synchronize timing with other host systems (e.g., compute nodes).

For example, time stamp counter (TSC) 114 can generate 1 pulse per second (1 PPS). TSC 114 can generate system time values (e.g., time of day in hours:minutes:seconds) based on time stamp values from ART main 112. A linear relationship can be used to synchronize time stamp values from ART main 112 and the time values from TSC 114. Non-linear relationships between TSC 114 and time stamp values of ART main 112 can be used such as second order, third order and so forth or any curve fitting.

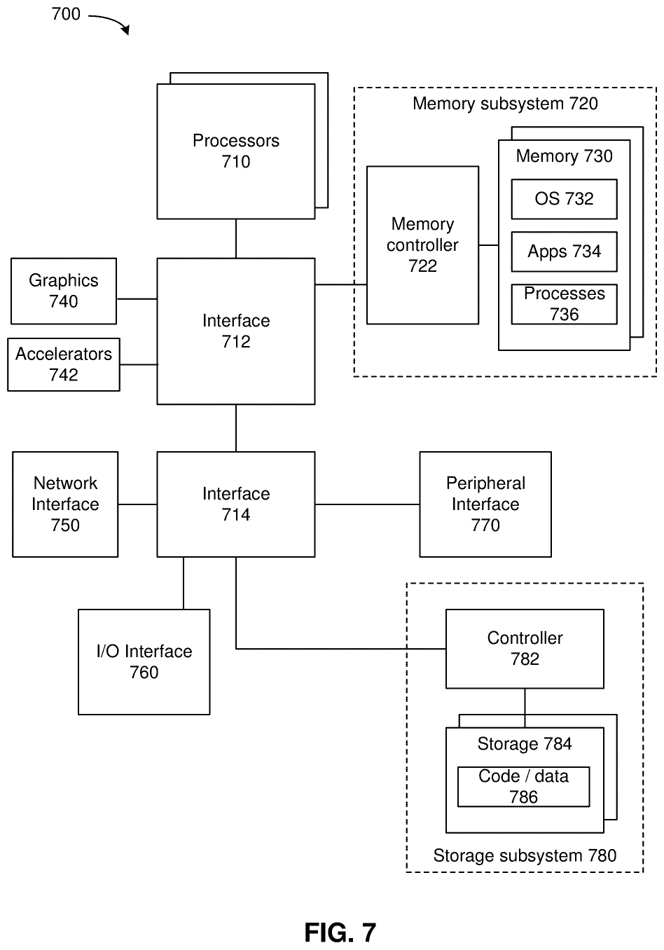

Various examples of circuitries 116 can include processors 102 executing processes 104, memory devices, network interface device 150, or other circuitries described with respect to FIG. 7. One or more of circuitries 116 can utilize time stamps from ART main 112 and/or clock signal from RCLK 110 to time performance of operations. For example, operations can include packet generation or insertion of a particular time stamp value in a packet.

In some examples, after synchronization with a clock signal from network clock 152, RCLK 110 can be synchronized again to a clock signal from clock source 170. For example, to save power during low network utilization, host 100 can turn off network interface device 150 or network clock 152, and host 100 can switch from synchronization with network clock source 150 to synchronization with crystal source 170. For example, where network interface device 150 is changed, such as on utilization of a replacement or additional field programmable gate array (FPGA), host 100 can switch from synchronization with a clock signal from network source 152 to synchronization with a clock signal from clock source 170.

An example of operations can be as follows. At (1), processor 102 and circuitries 116 can boot and operate using a clock signal generated from clock source 170. At (2), after a second clock signal from network clock 152, synchronized to network reference clock 160, is available, RCLK 110 can synchronize a clock signal to the second clock signal from network clock 152 by providing the clock signal but adjusting a phase and/or frequency of the clock signal to synchronize with the second clock signal so that processor 102, ART main 112, and circuitries 116 can receive the clock signal from RCLK 110. Accordingly, ART main 112 can be frequency synchronized with a main PTP timer from network reference clock source 160 with or without use of time stamp adjustment technologies such as linear or non-linear translations. At (3), based on a change in state of host 100, such as reduced power state, or disconnection of network interface device 150 from host system 100, RCLK 110 can synchronize merely to a clock signal from clock source 170.

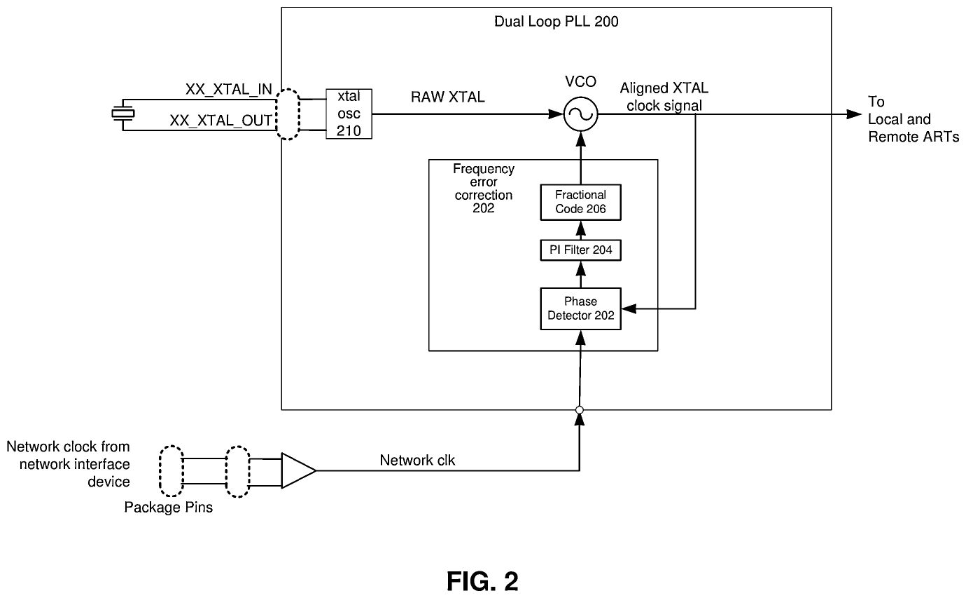

FIG. 2 depicts an example dual loop digital phase locked loop (DPLL). Although description is with respect to a digital PLL, an analog PLL can be used. When a clock signal based on a network clock is not present, the VCO output tracks the input from crystal oscillator 210 (XX_XTAL_IN). An example of this scenario occurs at startup where the clock signal based on the network clock is not available and the VCO output is a function of the crystal only and is synchronized to the clock signal (RAW XTAL) from crystal (xtal) oscillator 210. When a clock signal based on a network clock is present, digital phase detector 202 can determine a relationship between a clock signal output from the VCO (Aligned XTAL clock signal) and the network clock signal (Network clk). When the network clock signal is present, phase detector 202 can output a voltage based on the relationship between network clock (Network clk) and RAW XTAL to adjust a frequency Aligned XTAL clock signal to synchronize with the network clock signal.

Phase detector 202 can adjust the voltage of the VCO to align a clock signal output from the VCO with the network clock. Over time, Aligned XTAL clock signal becomes synchronized to the network clock. Proportional+integrator (PI) filter 204 can filter the response from phase detector 202 to track frequency or phase offsets and provide a corresponding output correction value to drive the loop to zero error. Fractional code circuitry 206 can adjust frequency of clock signal based on the output values from PI filter 204. In some examples, clock phase variation between Aligned XTAL clock signal and Network clk can be within the G.8262 (option 1) specification whereby output phase variation does not exceed 120 ns, with a maximum frequency offset of 7.5 ppm for a maximum period of 16 milliseconds (ms).

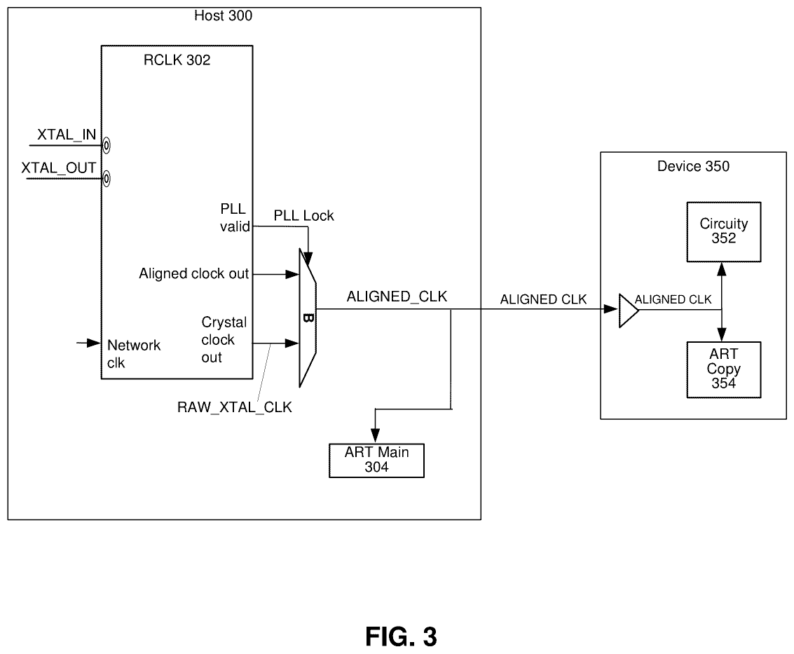

FIG. 3 depicts an example system. A clock signal from RCLK 302 can be part of a system on chip (SoC) or connected to host system 300 by a circuit board. RCLK 302 can output a clock signal (ALIGNED_ CLK), synchronized to a clock signal from a crystal clock source or network clock, to device 350. Device 350 can include one or more of: a graphics processing unit (GPU), second host system, memory device, storage device, accelerator, network interface device, or other circuitries. Device 350 can utilize a clock signal ALIGNED_XTAL_CLK as a clock signal for circuitry 352. Circuitry 352 can include one or more of: a direct memory access (DMA) circuitry, network interface, host interface, device interface, accelerator, memory device, storage device, or other device.

For example, ART main 304 can generate time stamps based on ALIGNED_CLK. In addition, device 350 can utilize ART copy 354 to generate time stamps based on ALIGNED_CLK. ART copy 354 can increment time stamp values based on edges of ALIGNED CLK. ART copy 354 can periodically update time stamps to match time stamps from ART main 304. Circuitry 352 can perform operations timed according to ALIGNED CLK or time stamp values from ART copy 354.

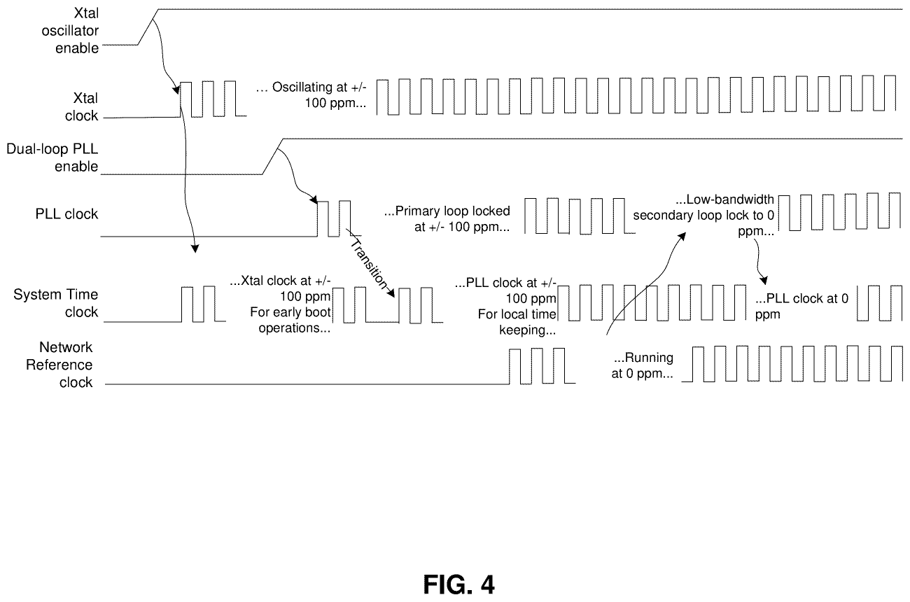

FIG. 4 depicts an example of signals. Crystal (Xtal) oscillator enable can cause output of a clock signal from a crystal oscillator. For example, the crystal oscillator can generate a clock signal oscillating with a variation in frequency of 100 parts per million (ppm) relative to a network clock. Dual-loop PLL enable can cause the PLL to lock to the clock signal from the crystal oscillator and output the System Time clock (e.g., ALIGNED CLK). System Time clock can oscillate with a variation in frequency of 100 ppm relative to a network clock and can be used as a clock source for boot operations and time keeper operations in the host. After network reference clock based on a network source is available, where the network reference clock runs at 0 ppm variance in frequency relative to a network clock, the PLL clock can lock to the network reference clock, which locks the System Time clock to the PLL clock. Accordingly, the System Time clock can be synchronized to the network reference clock with a variance of approximately 0 ppm.

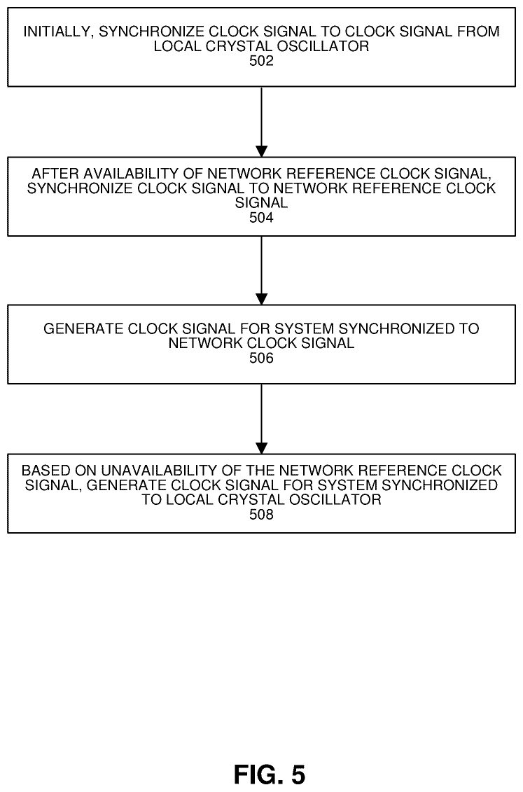

FIG. 5 depicts an example process. The process can be performed by a clock source in some examples. At 502, based on receipt of a clock signal from a crystal oscillator but not from a network interface device, a clock signal can be generated based on the clock signal from a crystal oscillator. At 504, based on receipt of a clock signal from the network interface device, the clock source can synchronize to the clock signal from the network interface device. The clock signal from the network interface device can be synchronized to network time based on PTP values received in Ethernet packets in accordance with IEEE-1588 from a network clock source or other timing signals or values. At 506, the clock source can output the clock signal synchronized to the clock signal from the network interface device. The output clock signal can be provided to generate ART values and copies of ART values to time synchronize circuitries connected to a processor, as described herein. At 508, based on an event such as unavailability of the clock signal from the network interface device, the clock source can synchronize to the clock signal from the crystal oscillator.

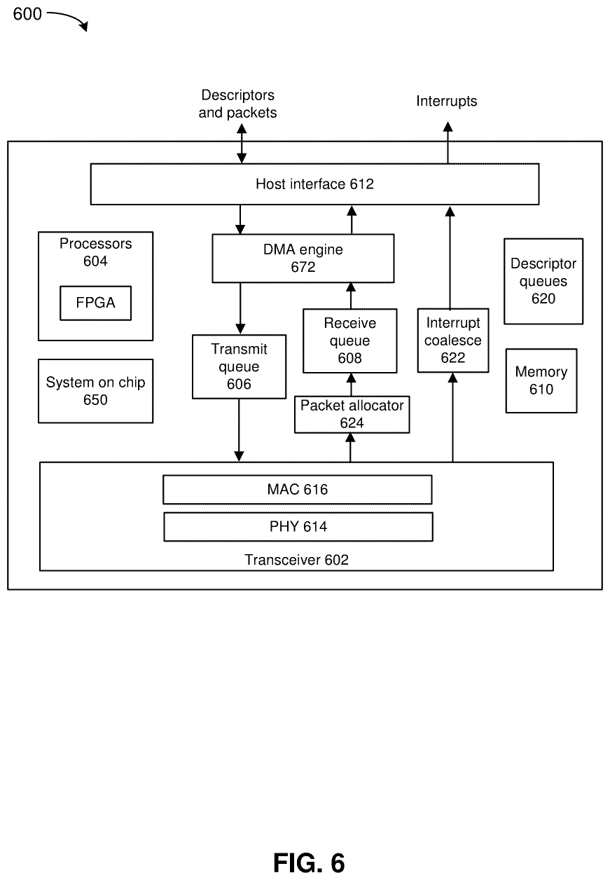

FIG. 6 depicts an example network interface. Various processor resources in the network interface can perform synchronizing clock signals to an on-chip crystal oscillator or synchronizing to an available clock signal from the network interface device, as described herein. In some examples, network interface 600 can be implemented as a network interface controller, network interface card, a host fabric interface (HFI), or host bus adapter (HBA), and such examples can be interchangeable. Network interface 600 can be coupled to one or more servers using a bus, PCIe, CXL, or DDR. Network interface 600 may be embodied as part of a system-on-a-chip (SoC) that includes one or more processors, or included on a multichip package that also contains one or more processors.

Some examples of network device 600 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to perform MAC address filtering on received packets, process MAC headers of received packets by verifying data integrity, remove preambles and padding, and provide packet content for processing by higher layers. MAC circuitry 616 can be configured to assemble data to be transmitted into packets, that include destination and source addresses along with network control information and error detection hash values.

Processors 604 can be any a combination of a: processor, core, graphics processing unit (GPU), field programmable gate array (FPGA), application specific integrated circuit (ASIC), or other programmable hardware device that allow programming of network interface 600. For example, a “smart network interface” or SmartNIC can provide packet processing capabilities in the network interface using processors 604.

Processors 604 can include a programmable processing pipeline that is programmable by P4, C, Python, Broadcom Network Programming Language (NPL), or x86 compatible executable binaries or other executable binaries. Processors, FPGAs, other specialized processors, controllers, devices, and/or circuits can be utilized for packet processing or packet modification. Ternary content-addressable memory (TCAM) can be used for parallel match-action or look-up operations on packet header content.

Packet allocator 624 can provide distribution of received packets for processing by multiple CPUs or cores using receive side scaling (RSS). When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with or based at least in part on PCI, PCI Express, PCI-x, Serial ATA, and/or USB (although other interconnection standards may be used), or proprietary variations thereof.

FIG. 7 depicts an example computing system. System 700 can be used to synchronizing clock signals to an on-chip crystal oscillator or synchronizing to an available clock signal from the network interface device, as described herein. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU).

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 750 can synchronize a clock signal to a network time and provide the clock signal. A clock source can synchronize a reference clock signal with the clock signal from network interface 750.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache.

A non-volatile memory (NVM) device is a memory whose state is determinate even if power is interrupted to the device.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples and includes at least an apparatus that includes: an interface and circuitry to generate a clock signal by synchronization with a second clock signal from a crystal source and subsequent synchronization with a third clock signal, wherein the third clock signal is synchronized to timing signals received in Ethernet packets and wherein the crystal source is to provide the second clock signal to the circuitry via the interface.

Example 2 includes one or more examples, wherein the timing signals received in Ethernet packets comprise one or more of: Precision Time Protocol (PTP) timing signals, IEEE 1588 timing signals, or Network Time Protocol (NTP) timing signals.

Example 3 includes one or more examples, wherein the subsequent synchronization is based on availability of the third clock signal.

Example 4 includes one or more examples, wherein based on reduction of power to the circuitry, the circuitry is to synchronize the clock signal with the second clock signal after synchronization with the third clock signal.

Example 5 includes one or more examples, and includes a processor coupled to receive the clock signal from the circuitry, wherein the processor is to execute a process that is to perform operations timed to the clock signal.

Example 6 includes one or more examples, and includes a network interface device to generate the third clock signal and to provide the third clock signal to the circuitry based on timing signals received in Ethernet packets and based on one or more of: Precision Time Protocol (PTP) timing signals, IEEE 1588 timing signals, or Network Time Protocol (NTP) timing signals.

Example 7 includes one or more examples, wherein the circuitry comprises one or more of: a phase locked loop (PLL) circuitry, delay locked loop (DLL), or a clock generator.

Example 8 includes one or more examples, wherein the circuitry is to provide the clock signal to a device, the device comprises second circuitry to perform data processing timed according to the clock signal, and the device comprises one or more of: an accelerator, a network interface device, a memory device, or a storage device.

Example 9 includes one or more examples, and includes a process of making a timing source comprising: a first interface a crystal oscillator; a second interface to a network interface device; and coupling the first interface to the second interface, wherein the timing source generates a clock signal by synchronization with a second clock signal from the crystal oscillator and subsequently synchronized with a third clock signal, wherein the third clock signal is synchronized to timing signals received in Ethernet packets.

Example 10 includes one or more examples, wherein the timing source comprises one or more of: a phase locked loop (PLL) circuitry, delay locked loop (DLL), or a clock generator.

Example 11 includes one or more examples, wherein the synchronize with the third clock signal comprises providing a time stamp value timed to the clock signal and receiving a second time stamp value timed to the third clock signal and wherein the second time stamp value corresponds to the time stamp value.

Example 12 includes one or more examples, and includes a method that includes: generating a clock signal by synchronization with a second clock signal from a crystal source and subsequently synchronizing the clock signal with a third clock signal, wherein the third clock signal is synchronized to timing signals received in Ethernet packets.

Example 13 includes one or more examples, wherein the timing signals received in Ethernet packets comprise one or more of: Precision Time Protocol (PTP) timing signals, IEEE 1588 timing signals, or Network Time Protocol (NTP) timing signals.

Example 14 includes one or more examples, wherein the subsequent synchronizing is based on availability of the third clock signal.

Example 15 includes one or more examples, wherein based on reduction of power of a source of the third clock signal, synchronizing the clock signal with the second clock signal after synchronization with the third clock signal.

Example 16 includes one or more examples, and includes executing a process that performs operations timed to the clock signal.

Example 17 includes one or more examples, and includes a network interface device generating the third clock signal based on timing signals received in Ethernet packets and based on one or more of: Precision Time Protocol (PTP) timing signals, IEEE 1588 timing signals, or Network Time Protocol (NTP) timing signals.

Example 18 includes one or more examples, and includes synchronizing the clock signal with the second clock signal and the third clock signal by one or more of: a phase locked loop (PLL) circuitry, delay locked loop (DLL), or a clock generator.

Example 19 includes one or more examples, and includes performing, by a device, data processing timed according to the clock signal, wherein the device comprises one or more of: an accelerator, a network interface device, a memory device, or a storage device.

Example 20 includes one or more examples, wherein the generating the clock signal by synchronization with the second clock signal from the crystal source and subsequently synchronizing the clock signal with the third clock signal utilize a phase detector and proportional+integrator (PI) filter.

What is claimed is:

1. An apparatus comprising:
an interface and
circuitry to generate a clock signal by synchronization with a second clock signal from a crystal source and subsequent synchronization with a third clock signal, wherein the third clock signal is synchronized to timing signals received in Ethernet packets and wherein the crystal source is to provide the second clock signal to the circuitry via the interface.

2. The apparatus of claim 1, wherein the timing signals received in Ethernet packets comprise one or more of: Precision Time Protocol (PTP) timing signals, IEEE 1588 timing signals, or Network Time Protocol (NTP) timing signals.

3. The apparatus of claim 1, wherein the subsequent synchronization is based on availability of the third clock signal.

4. The apparatus of claim 1, wherein:
based on reduction of power to the circuitry, the circuitry is to synchronize the clock signal with the second clock signal after synchronization with the third clock signal.

5. The apparatus of claim 1, comprising:
a processor coupled to receive the clock signal from the circuitry, wherein the processor is to execute a process that is to perform operations timed to the clock signal.

6. The apparatus of claim 1, comprising:
a network interface device to generate the third clock signal and to provide the third clock signal to the circuitry based on timing signals received in Ethernet packets and based on one or more of: Precision Time Protocol (PTP) timing signals, IEEE 1588 timing signals, or Network Time Protocol (NTP) timing signals.

7. The apparatus of claim 1, wherein the circuitry comprises one or more of: a phase locked loop (PLL) circuitry, delay locked loop (DLL), or a clock generator.

8. The apparatus of claim 1, wherein:
the circuitry is to provide the clock signal to a device,
the device comprises second circuitry to perform data processing timed according to the clock signal, and
the device comprises one or more of: an accelerator, a network interface device, a memory device, or a storage device.

9. A process of making a timing source comprising:
a first interface a crystal oscillator;
a second interface to a network interface device; and
coupling the first interface to the second interface, wherein the timing source generates a clock signal by synchronization with a second clock signal from the crystal oscillator and subsequently synchronized with a third clock signal, wherein the third clock signal is synchronized to timing signals received in Ethernet packets.

10. The process of claim 9, wherein the timing source comprises one or more of: a phase locked loop (PLL) circuitry, delay locked loop (DLL), or a clock generator.

11. The process of claim 9, wherein the synchronize with the third clock signal comprises providing a time stamp value timed to the clock signal and receiving a second time stamp value timed to the third clock signal and wherein the second time stamp value corresponds to the time stamp value.

12. A method comprising:
generating a clock signal by synchronization with a second clock signal from a crystal source and
subsequently synchronizing the clock signal with a third clock signal, wherein the third clock signal is synchronized to timing signals received in Ethernet packets.

13. The method of claim 12, wherein the timing signals received in Ethernet packets comprise one or more of: Precision Time Protocol (PTP) timing signals, IEEE 1588 timing signals, or Network Time Protocol (NTP) timing signals.

14. The method of claim 12, wherein the subsequent synchronizing is based on availability of the third clock signal.

15. The method of claim 12, wherein:
based on reduction of power of a source of the third clock signal, synchronizing the clock signal with the second clock signal after synchronization with the third clock signal.

16. The method of claim 12, comprising:
executing a process that performs operations timed to the clock signal.

17. The method of claim 12, comprising:
a network interface device generating the third clock signal based on timing signals received in Ethernet packets and based on one or more of: Precision Time Protocol (PTP) timing signals, IEEE 1588 timing signals, or Network Time Protocol (NTP) timing signals.

18. The method of claim 12, comprising:
synchronizing the clock signal with the second clock signal and the third clock signal by one or more of: a phase locked loop (PLL) circuitry, delay locked loop (DLL), or a clock generator.

19. The method of claim 12, comprising:
performing, by a device, data processing timed according to the clock signal, wherein the device comprises one or more of: an accelerator, a network interface device, a memory device, or a storage device.

20. The method of claim 12, wherein the generating the clock signal by synchronization with the second clock signal from the crystal source and subsequently synchronizing the clock signal with the third clock signal utilize a phase detector and proportional+integrator (PI) filter.
